(19) United States
(12) Patent Application Publication
(10) Pub. No.: US 2012/0003130 A1
(43) Pub. Date: Jan. 5, 2012

(54) ALUMINA PRODUCTION PROCESS

(75) Inventor: Giorgio Vidili, Iglesias (CI) (IT)

(73) Assignee: TECNOCHEM S.R.L., Iglesias (CI) (IT)

(21) Appl. No.: 12/863,916

(22) PCT Filed: Jan. 22, 2008
(86) PCT No.: PCT/IT2008/000031

§ 371 Date: Sep. 16, 2010

(51) Int. Cl. C01F 7/02

(52) U.S. Cl. 423/127

(57) ABSTRACT

An improved process for producing alumina from bauxite is disclosed comprising the steps of:
a) wet grinding of the bauxite in the presence of an agent capable of reducing the viscosity of the semiliquid paste obtained;
b) caustic etching of the bauxite ground in step a) with a concentrated solution of sodium hydroxide until a liquid phase is obtained comprising aluminium hydroxide and a solid phase;
c) removal of the solid phase formed in step b) from the liquid phase;
d) precipitation of the aluminium hydroxide from the liquid phase of step c);
e) filtration of the aluminium hydroxide precipitated in step d); and
f) calcination of the aluminium hydroxide of step e).

The present invention relates to a process for producing alumina.

More in particular, the present invention relates to an improved Bayer process for producing alumina from bauxite.

It is known that the Bayer process consists of producing alumina from bauxite by heating the latter in a sodium hydroxide solution.

It is also known that bauxite is a rock with an earthy appearance the basic constituents of which consist of aluminium hydroxide Al(OH)₃ and of aluminium oxide hydroxide AlO(OH). In addition to the two aluminium hydroxides, bauxites often contain quantities, even very significant quantities, of trivalent iron oxides, of silicon present as quartz or hydrated silicon or in the form of hydrated aluminium silicates, of small quantities of titanium oxide and sometimes also of traces of carbonates and of calcium and of magnesium phosphates.

In general, the Bayer process comprises the steps of grinding the bauxite to subject the ground bauxite to caustic etching using a concentrated solution of sodium hydroxide until a liquid-solid phase is obtained comprising aluminium hydroxide, separating the formed solid phase from the liquid phase, precipitating the aluminium hydroxide from the liquid phase, filtering the precipitated aluminium hydroxide and calcinating the aluminium hydroxide to obtain alumina.

Normally, concentrated solutions of sodium hydroxide are used (200-400 grams of NaOH per litre) and operations are performed at temperatures varying from 120-140° C. for bauxites that are more readily etchable, i.e. those richer in Al(OH)₃, at 200-250° C. for less reactive bauxites, i.e. richer in aluminium oxide hydroxide.

These temperatures are greater than the boiling temperature of the sodium hydroxide solutions at atmospheric pressure, so operations must be conducted in an autoclave at pressures that can reach 35 atmospheres.

Sodium hydroxide reacts with aluminium compounds present in the bauxite, transforming the aluminium compounds into sodium aluminate that is soluble in the liquid phase NaAlO₂(water). The anhydrous and hydrated iron oxides in the conditions in which operations are conducted are not actually etched and remain in solid state. This also occurs with titanium compounds. Most of the silicon reacts with the sodium hydroxide in a solution in the form of sodium silicate. As soon as this compound has been formed it reacts with the sodium aluminate to give rise to insoluble hydrated sodium aluminosilicate, which precipitates and unites with the impurities that have remained unetched.

At the end of the etching operation in the autoclave there is a liquid phase, in which the sodium aluminosilicate and the excess sodium hydroxide are dissolved that did not participate in the reactions disclosed above and a solid phase consisting of anhydrous and hydrated iron oxide, composed of titanium compounds and sodium aluminosilicate. This insoluble residue is known as sand and mud.

The Bayer process then provides for a first dilution with water and decanting and washing operations to separate the liquid phase from the sand and mud.

After final filtration to eliminate the last traces of insoluble substances, the sodium aluminate solution and significantly diluted sodium hydroxide, the temperature of which has fallen to 50-60° C., is left to stand for a few dozen hours in large tanks, where partial hydrolysis of the alumina with the formation of insoluble gibbsite takes place.

The reaction is very slow and in order to accelerate the precipitation of the aluminium hydroxide Al(OH)₃(s), and obtain a more readily filterable product, a certain quantity of previously precipitated hydroxide is introduced into the solution, the grains of which act as crystallization germs.

Filtration is then performed, normally using rotating drum filters, and the solid aluminium hydroxide is thus separated from the liquid phase that consists of a now rather diluted solution of NaOH still with non hydrolyzed NaAlO₂.

The solution is concentrated by evaporating a part of the water in a series of multiple-effect evaporators, and the solution is recycled, being reused to etch the bauxite.

The aluminium hydroxide is on the other hand subjected to calcination at approximately 1200° C. in rotating kilns.

The first bauxite grinding step is a wet grinding step in which both the bauxite introduced into the rotating mills through a loading hopper and the caustic solution returning from the hydrate precipitation zone are loaded.

Bauxite already has a wetness that is proper to it that is typical of the mineral that is usually increased with calcium and sodium milk or with caustic soda alone as in the Bayer process disclosed here.

It is known that bauxite grinding mills are cylindrical in shape and are subdivided internally into two separate chambers by a drilled diaphragm. In the first chamber there are grinding bars, in the second there are grinding balls. Said mills can also consist of only bars or of only balls.

A third of the volume of the machining mill is usually filled with the bars and with the balls, and another third of the volume is filled with the wet bauxite. The last third of the mill is left empty for the grinding motion.

The object of these mills is to reduce the dimension of the bauxite granules to enable more complete and efficient extraction of the sodium aluminate by the subsequent caustic etching with the concentrated solution of sodium hydroxide.

The product of the wet grinding step is a semiliquid paste with an approximately 50% solids content, which is known as bauxite slurry.

This semiliquid paste has to be pumped by the grinding mills inside an autoclave in order to be able to run the subsequent caustic etching steps.

Nevertheless, the aforesaid semiliquid paste is very viscous (with viscosity comprised between 1100 and 1400 cps for bauxite loads comprised between 400 and 500 tonnes/hour) and this has numerous technical drawbacks.

In fact, the great viscosity of the semiliquid paste causes great power consumption by the pumps that have to convey the highly viscous semiliquid paste from the mills to the processing autoclave. This decreases the overall productive capacity of the plant for obtaining alumina.

Further, the presence of a highly viscous semiliquid paste inside the grinding mills and inside the pumps conveying to the autoclave dirties the aforesaid machines in a consistent manner. This thus makes it necessary to perform numerous cleaning operations on the mills and the pumps to use the mills and the pumps subsequently. Wear to said pumps is consequently very rapid.

The technical problem at the basis of the present invention is to provide an improved Bayer process for producing alumina from bauxite that does not have the aforesaid drawbacks.

According to the present invention, this drawback is resolved by an improved Bayer process comprising the steps of:
a) wet grinding of the bauxite and obtaining a semiliquid paste;
b) caustic etching of the bauxite ground in step a) with a concentrated solution of sodium hydroxide until a liquid phase is obtained comprising aluminium hydroxide and a solid phase;
c) removal of the solid phase formed in step b) from the liquid phase;
d) precipitation of the aluminium hydroxide from the liquid phase of step c);
e) filtration of the aluminium hydroxide precipitated in step d); and
f) calcination of the aluminium hydroxide of step e), said process being characterised in that the bauxite grinding step a) is performed in the presence of an agent capable of reducing the viscosity of said semiliquid paste.

Advantageously, the agent capable of reducing the viscosity of the present invention is introduced into the loading hopper of the grinding mills whilst the latter is traversed by the bauxite.

In a first embodiment of present invention, the agent capable of reducing the viscosity of the aforesaid semiliquid paste is a composition comprising water, an ethylene oxide/propylene oxide copolymer, dioctyl sulphosuccinate and butylene glycol.

Preferably, the agent of the first embodiment is a composition comprising from 65 to 75% (p/p) water, from 5 to 15% (p/p) ethylene oxide/propylene oxide copolymer, from 5 to 15% (p/p) dioctyl sulphosuccinate and from 5 to 15% (p/p) butylene glycol.

Still more preferably, said agent of the first embodiment is a composition comprising 70% (p/p) water, 10% (p/p) ethylene oxide/propylene oxide copolymer, 10% (p/p) dioctyl sulphosuccinate and 10% (p/p) butylene glycol.

In a second embodiment of the present invention, the agent that is capable of reducing the viscosity of the aforesaid semiliquid paste is a composition comprising water, sodium alkyl ether sulphate (for example “Sodium C12-C15 Pareth Sulphate”), an alkyl amido propyl betaine water solution, an ethylene oxide/propylene oxide copolymer and a sodium hydroxide water solution.

Preferably, said agent of the second embodiment is a composition comprising from 75 to 85% (p/p) water, from 10 to 15% (p/p) sodium alkyl ether sulphate, from 1 to 3% (p/p) alkyl amido propyl betaine water solution, from 3.5 to 5.5% (p/p) of an ethylene oxide/propylene oxide copolymer and from 0.5 to 2.5% (p/p) of a sodium hydroxide water solution.

Still more preferably, said agent of the second embodiment is a composition comprising 80% (p/p) water, 12.3% (p/p) sodium alkyl ether sulphate in which the alkyl is linear or ramified, saturated or insaturate, the 2% (p/p) alkyl amido propyl betaine water solution in which the alkyl is linear or ramified, saturate or insaturate, 4.4% (p/p) ethylene oxide/propylene oxide copolymer and 1.3% (p/p) sodium hydroxide water solution.

A preferred example of sodium hydroxide water solution in the agent capable of reducing the viscosity of the aforesaid semiliquid paste of the second embodiment contains 30% (p/p) sodium hydroxide.

In a third embodiment of the present invention, said agent is a composition comprising limonene, glycol ethers (for example “methoxy propanol”), salt-free octyl iminodiproprionate (for example “octyl iminodipropionate”), alkyl glucoside (for example “alkyl C8 glucoside”) in water solution and an alcohol ethoxylate (for example “alcohol C9-C11+EO”).

Preferably, said agent of the third embodiment comprises from 35 to 45% (p/p) limonene, from 5 to 15% (p/p) glycol ethers, from 1 to 3% (p/p) salt-free octyl iminodiproprionate, from 1 to 3% (p/p) alkyl glucoside in water solution and from 40 to 50% (p/p) alcohol ethoxylate,

Still more preferably, said agent of the third embodiment comprises 40% (p/p) limonene, 10% (p/p) glycol ethers, 2.5% (p/p) salt-free octyl iminodiproprionate, 2.5% (p/p) alkyl glucoside, in water solution and 45% (p/p) alcohol ethoxylate.

Wet grinding occurs in spent liquor.

Advantageously, the agent capable of reducing the viscosity of the semiliquid paste produced in grinding step a) of the present invention is added in a quantity comprised between 40 and 60 grams of agent for each tonne of bauxite.

Still more advantageously, the agent capable of reducing the viscosity of the semiliquid paste produced in grinding step a) of the present invention is added in a quantity of 50 grams of agent for each tonne of bauxite.

From the above remarks the advantages of the process of the present invention are immediately clear.

As will be clear from the following examples, the presence of the agent reduces the viscosity of the semiliquid paste produced in the bauxite grinding step) by more than 70% compared with the viscosity that said paste would have in the absence of the agent of the present invention.

Said reduction of viscosity makes said semiliquid paste more flowable, facilitating the passage thereof from the grinding mills to the autoclave in which caustic etching of the bauxite takes place.

Pump operation is thus facilitated, further reducing the electric energy consumption of said conveying pumps conveying the semiliquid paste from the grinding mills to the aforesaid autoclave with an energy saving of up to 30%.

The increase in the flowing capacity of the semiliquid paste further enables more efficient maintenance of the production plant producing alumina to be obtained as the mills and the pumps remain cleaner with lowering of extraordinary maintenance costs up to 70%.

Laboratory tests conducted by the applicant using a rheometer (for example “DV III Brookfield rheometer”) have shown that the agent capable of reducing the viscosity of the semiliquid paste of the present invention also reduces torque and shear stress.

A further advantage is that the agent capable of reducing the viscosity of the semiliquid paste of the present invention is chemically inert compared with wet bauxite in granules. Substantially, the viscosity-reducing agent surrounds the bauxite granules without interacting chemically therewith, making the corresponding motion between bauxite granules more fluid. This avoids the need to perform successive steps of removing by-products of possible undesired reactions.

The agent capable of reducing the viscosity of the semiliquid paste of the present invention is removed by simple evaporation in the subsequent step of caustic etching of the bauxite in the autoclave. This avoids the need to perform subsequent steps of removing said agent from the final alumina obtained.

The interaction between the bauxite and the agent according to the present invention is merely physical.

The presence of the agent capable of reducing the viscosity of the semiliquid paste of the present invention enables the productive efficiency of the plant to be thus recovered to obtain up to 80% alumina.

Another advantage is that the presence of the agent capable of reducing the viscosity of the semiliquid paste of the present invention enables the same quantity of alumina to be obtained using only two rotating mills instead of the three rotating mills traditionally used during the bauxite grinding step in the traditional Bayer process. It is thus possible to stop the possible third mill for extraordinary maintenance operations without production losses. Such mills have very great costs, so normally there at most three mills for each plant. Stopping just one mill entails reducing production by a third. In the absence of the reducing agent according to the present invention, a possible attempt to increase the production of the two remaining mills, which are normally working at full capacity, may damage these mills.

Small variations to the dose of the agent enable production to be controlled without damaging the plant.

Let the following examples illustrate the present invention without in any way limiting the scope thereof.

### EXAMPLE 1

### Preparing an Agent Capable of Reducing the Viscosity of the Semiliquid Paste According to the Present Invention—Ga1

| Components of the agent GA1 | % (p/p) |
|---|---|
| Water | 70 |
| Ethyl oxide/propylene oxide copolymer | 10 |
| Dioctyl sulphosuccinate | 10 |
| Butylene glycol | 10 |

The aforesaid agent Ga1 according to the present invention is prepared by mixing the aforesaid components in the aforementioned order in a mixer with blades of traditional type at ambient temperature and at atmospheric pressure with stirring of approximately 100-200 rpm for 1-2 hours. Stirring speed is increased progressively.
The obtained composition has the following chemical and physical features:
flash point: >55° C.
ignition point: 240° C.

### EXAMPLE 2

### Preparing an Agent Capable of Reducing the Viscosity of the Semiliquid Paste According to the Present Invention—Ga2

| Components of the agent GA2 | % (p/p) |
|---|---|
| Limonene | 40 |
| Glycol ethers | 10 |
| Octyl iminodiproprionate, salt-free | 2.5 |
| Alkyl glucoside water solution | 2.5 |
| Alcohol ethoxylate | 45 |

The aforesaid agent GA2 according to the present invention is prepared by mixing the aforesaid components in the aforesaid order in a blade mixer of traditional type at 40° C. (preheating, for example by means of a tube bundle) and at atmospheric pressure with stirring of approximately 100-200 rpm for 1-2 hours. Stirring speed is increased progressively.
The composition obtained has the following chemical and physical features:
flash point: >29-55° C.
ignition point: 255° C.

### EXAMPLE 3

### Preparing an Agent Capable of Reducing the Viscosity of the Semiliquid Paste According to the Present Invention—Ga3

| Component of the agent GA3 | % (p/p) |
|---|---|
| Water | 80 |
| Alkyl amido propyl betaine water solution | 2 |
| Ethyl oxide/propylene oxide copolymer | 4.4 |
| 30% caustic soda | 1.3 |

The aforesaid agent GA3 according to the present invention is prepared by mixing the aforesaid components in the aforesaid order in a blade mixer of traditional type at ambient temperature and at atmospheric pressure with stirring at approximately 100-200 rpm for 1-2 hours. Stirring speed is increased progressively.
The composition obtained had the following chemical and physical features:
flash point: >100° C.
ignition point: insignificant.

### EXAMPLE 4

### Tests of Reduction of Viscosity of the Semiliquid Paste During the Grinding Step by Means of the Agent Ga2 of the Present Invention

| Viscosity | Viscosity with | Speed of bauxite | |
|---|---|---|---|
| without agent | agent GA2 | loading | Reduction of |
| GA2 (cps) | (cps) | (tonnes/hour) | viscosity (%) |
| 1321 | 355 | 440 | 73.13 |
| 1338 | 370 | 450 | 72.35 |
| 1325 | 483 | 450 | 63.55 |
| 1337 | 478 | 450 | 64.25 |
| 1245 | 430 | 460 | 65.46 |
| 1310 | 438 | 460 | 66.56 |
| 1255 | 341 | 460 | 72.83 |
| 1330 | 384 | 470 | 71.13 |
| 1295 | 400 | 470 | 69.11 |

Viscosity was measured by a PIVI portable viscometer (Sofraser, France). With the agents GA1 and GA3 similar results were obtained.

### EXAMPLE 5

### Improved Bayer Process According to the Present Invention

The process for producing alumina was conducted in a Spanish plant in Galicia according to the following steps. It should be noted that the plant was first “conditioned” by rotating the grinding mill with the wet bauxite in the absence of the agent Ga2, which is initially injected into the slurry leaving the mill for 24-48 hours (preferably 48 hours). If GA1 or GA3 is used conditioning has to occur with the latter agents respectively.

Grinding step a). The bauxite (1 tonne) was ground wet in the presence of liquor and of the agent GA2 (50 grams) of the present invention.

The spent liquor and the agent GA2 were introduced into the grinding mill together with the bauxite.

The mill used is known and of the type subdivided into two chambers separated by a drilled diaphragm. In the first chamber there are grinding bars, in the second grinding balls. Said mill could also have only bars or only balls.

A ⅓ of the volume of the mill was filled by the bars or by the balls and another third was filled by the wet bauxite. The last third of the mill was left empty for the grinding motion. The addition of the agent GA2 (50 g for each tonne of wet bauxite) did not significantly vary the free third of the volume. No particular calculations are therefore necessary for redistributing space inside the mill.

In general, the quantity of agent GA2 to be inserted varies in function of the type of bauxite processed, the type of mill, the state of wear to the system and in particular to the mill. There is in fact provided a first running-in step to define the exact quantity of GA2 that will remain within the 40-60 g interval per tonne of bauxite. The same comments apply to GA1 and GA3.

One of the great advantages connected with the present invention, is the capacity to increase in a substantial manner the efficiency even of mills that have been in operation for several years. The agents reducing viscosity according to the present invention have a cleaning effect on the mills owing to the properties of the substances comprising said agents GA1, GA2 and GA3.

The results obtained for various bauxite loads are set out in the table of example 4.

Caustic etching step b). The semiliquid paste formed in the preceding grinding step was pumped into the autoclave for caustic etching by high-pressure alternating pumps of traditional type and subjected to caustic etching with a concentrated solution of sodium hydroxide with concentrations, temperature and pressure normally used in Bayer processes for approximately 10 minutes during which the aluminium hydrate was totally solubilised (97% etching efficiency).

In said caustic etching step, 60-80% of the dry weight of bauxite was dissolved, and the processing residues (sand and mud) were left suspended.

The solution used for caustic etching of the bauxite which was now rich in dissolved alumina was cooled during evaporation stages at pressures decreasing gradually to atmospheric pressure (“flash tanks” or expansion tank. At the end of said step b) there is no trace of the agent GA2, which has evaporated. The agent GA2 is in fact chemically inert.

Removal of solid or clarification step c). The undissolved bauxite was separated in the sand separating and mud settling plants. The sand essentially consisted of quartz silicon located in the loaded bauxite that was mostly unetched. The unloaded sand was subjected to washing against the current with plant liquid with a low sodium hydroxide content and was then removed from the plant after up to 70% of the solids had been removed from the liquid. The quantities of unloaded sand were equal to approximately 2.5% of the loaded cold bauxite. The mud, on the other hand, was removed by gravity separation in continuous settlers, from which the thickened mud was sent for washing and recovery of the sodium hydroxide and of the alumina contained therein.

The liquid leaving the clarification step is called “pregnant liquor” in view of the concentration of alumina in a supersaturate solution.

The mud separated in the aforesaid clarification step c) was supplied to a series of settlers where it was washed with water in a washer.

Each washing unit consisted of a mixing tank and of a tank with a conical bottom where the mud was thickened with 30% solids and was tapped from the bottom.

After the last washing unit, the mud was sent to a set of rotating filters where it underwent further washing with condensate and was finally removed thickened to 60% solids.

The filtered washing liquid was then washed against the current in the sequence of washers to recover the sodium hydroxide and the alumina and was then introduced into the main flow exiting the etching where dilution takes place.

The “pregnant liquor” was sent, after being separated from the mud, to the area in which the heat exchange occurs where it was cooled by transferring heat to the concentrated solution of sodium hydroxide used for caustic etching that was now spent that was returned from the end of the preceding cycle.

Precipitation step d). The “pregnant liquor” cooled by heat exchange was supplied to the precipitation sequences, where, mixed with the seed of spent aluminium hydrate (seed load) it gave rise to the solid-phase precipitation of the hydrate that had been until then made into a solution as a solid aluminate. The precipitation reaction caused a long period of coexistence of the precipitating liquid with the seed load-support (about 72 hours) so as to obtain the desired increase.

During precipitation, the liquid was stirred continuously so as to keep the grains of already crystallized hydrate in contact with the liquid in the precipitation step.

The crystallized aluminium hydrate on the supporting surface provided by the seed load and by the new precipitation cores was separated in gravity classification units into three products of different granulometric classes.

The hydrate with coarse or “primary” granulometry was separated, tapped in the form of a liquid-solid suspension from the conical bottom of the apparatuses and constitutes the supply to the calcination kilns.

The plant liquid was made to advance in subsequent appliances, separating the hydrate with fine or “secondary and tertiary” granulometry that was continuously recycled at the head of the precipitation and at the head of the fourth precipitators, where an intermediate seed load was bestowed.

Calcination step f). The primary hydrate sent by the classification was subjected to filtration and washing with the recovered water of the plant liquid. The primary hydrate was supplied to the calcination kilns in which it was taken to a temperature of approximately 1200° C. and lost the imbibing and crystallising water, becoming alumina.

The operations of introducing the materials and extracting the finished products and residues were conducted in a balanced manner, i.e. according to values and ratios that are such as to prevent accumulation or shortages of materials inside the appliances. The aforesaid process can be repeated with similar results with the agents GA1 and GA3 according to the present invention.

The choice between the three agents disclosed above is made in function of the supplying capacity of the components. Each component is subject over time to variations in cost and available amount according to known market laws (also in function of the geographical region of implementation of the invention). This applicant thus provides the possibility to choose between products with similar effects but with costs that are variable over time (over the twenty years of the life of the patent costs will certainly change).

Substantially, the novelty and the originality of the present invention relate only to the grinding step a), the known procedures and operating parameters of the remaining steps not being changed, the latter nevertheless benefiting from the innovation applied to the first grinding step.

1. Improved process for producing alumina from bauxite comprising the steps of:
a) wet grinding of the bauxite and obtaining a semiliquid paste;
b) caustic etching of the bauxite ground in step a) with a concentrated solution of sodium hydroxide until a liquid phase is obtained comprising aluminium hydroxide and a solid phase;
c) removal of the solid phase formed in step b) from the liquid phase;
d) precipitation of the aluminium hydroxide from the liquid phase of step c);
e) filtration of the aluminium hydroxide precipitated in step d); and
f) calcination of the aluminium hydroxide of step e),
said process being characterised in that the bauxite grinding step a) is performed in the presence of an agent capable of reducing the viscosity of said semiliquid paste.

2. Process according to claim 1, wherein the agent capable of reducing the viscosity of the semiliquid paste of the grinding step a) is added in a quantity comprised between 40 and 60 grams of agent for each tonne of wet bauxite.

3. Process according to claim 2, wherein the agent capable of reducing the viscosity of the semiliquid paste is added in a quantity of 50 grams of agent for each tonne of wet bauxite.

4. Process according to claim 1, wherein the agent capable of reducing the viscosity of the semiliquid paste is chemically inert.

5. Process according to claim 1, wherein a plant conditioning step precedes grinding step a) that provides the operation of the grinding machine with wet bauxite in the absence of an agent reducing the viscosity that is injected into the semiliquid paste leaving the grinding machine, said conditioning step lasting 24-48 hours.

6. Process according to claim 1, wherein the agent is capable of reducing the torque and shearing stress of the semiliquid paste.

7. Process according to claim 1, wherein said agent capable of reducing the viscosity of said semiliquid paste is a composition (GA1) comprising water, an ethylene oxide/propylene oxide copolymer, dioctyl sulphosuccinate and butylene glycol.

8. Process according to claim 7, wherein said composition (GA1) comprises 65 to 75% (p/p) water, from 5 to 15% (p/p) ethylene oxide/propylene oxide copolymer, from 5 to 15% (p/p) dioctyl sulphosuccinate and from 5 to 15% (p/p) butylene glycol.

9. Process according to claim 8, wherein said composition (GA1) comprises 70% (p/p) water, 10% (p/p) ethylene oxide/propylene oxide copolymer, 10% (p/p) dioctyl sulphosuccinate and 10% (p/p) butylene glycol.

10. Process according to claim 1, wherein said agent is a composition (GA3) comprising water, sodium alkyl ether sulphate, an alkyl amido propyl betaine water solution, an ethylene oxide/propylene oxide copolymer and a sodium hydroxide water solution.

11. Process according to claim 10, wherein said composition (GA3) comprising from 75 to 85% (p/p) water, from 10 to 15% (p/p) alkyl ether sulphate sodium alkyl ether sulphate, from 1 to 3% (p/p) of an alkyl amido propyl betaine water solution, from 3.5 to 5.5% (p/p) of an ethylene oxide/propylene oxide copolymer and from 0.5 to 2.5% (p/p) sodium hydroxide water solution.

12. Process according to claim 11, wherein said composition (GA3) comprises 80% (p/p) water, 12.3% (p/p) sodium alkyl ether sulphate, 2% (p/p) of an alkyl amido propyl betaine water solution, 4.4% (p/p) of an ethylene oxide/propylene oxide copolymer and 1.3% (p/p) sodium hydroxide water solution.

13. Process according to claim 10, wherein the sodium hydroxide water solution contains 30% (p/p) sodium hydroxide.

14. Process according to claim 1, wherein said agent is a composition (GA2) comprising limonene, glycol ethers, salt-free octyl iminodiproprionate, alkyl glucoside in water solution and an alcohol ethoxylate.

15. Process according to claim 14, wherein in said composition (GA2) comprises 35 to 45% (p/p) limonene, 5 to 15% (p/p) glycol ethers, from 1 to 3% (p/p) salt-free octyl iminodiproprionate, 1 to 3% (p/p) alkyl glucoside in water solution and 40 to 50% (p/p) alcohol ethoxylate.

16. Process according to claim 15, wherein said composition (GA2) comprises 40% (p/p) limonene, 10% (p/p) glycol ethers, 2.5% (p/p) salt-free octyl iminodiproprionate, 2.5% (p/p) alkyl glucoside in water solution and 45% (p/p) alcohol ethoxylate.

17. Process according to claim 2, wherein the agent capable of reducing the viscosity of the semiliquid paste is chemically inert.

18. Process according to claim 3, wherein the agent capable of reducing the viscosity of the semiliquid paste is chemically inert.

19. Process according to claim 2, wherein a plant conditioning step precedes grinding step a) that provides the operation of the grinding machine with wet bauxite in the absence of an agent reducing the viscosity that is injected into the semiliquid paste leaving the grinding machine, said conditioning step lasting 24-48 hours.

20. Process according to claim 3, wherein a plant conditioning step precedes grinding step a) that provides the operation of the grinding machine with wet bauxite in the absence of an agent reducing the viscosity that is injected into the semiliquid paste leaving the grinding machine, said conditioning step lasting 24-48 hours.
